(19) United States
(12) Patent Application Publication
(10) Pub. No.: US 2003/0181591 A1
(43) Pub. Date: Sep. 25, 2003

(54) Polymer blends containing polyamide and rubber modified polymers produced by a mass polymerization method

(76) Inventors: Holger Warth, Dormagen (DE); Gerwolf Quaas, Koln (DE); Dieter Wittmann, Leverkusen (DE)

Correspondence Address: BAYER POLYMERS LLC, 100 BAYER ROAD, PITTSBURGH, PA, 15205, US

(21) Appl. No.: 10/276,234

(22) PCT Filed: May 7, 2001
(86) PCT No.: PCT/EP01/05140

(30) Foreign Application Priority Data
May 19, 2000 (GB) 100 24 933.7
May 19, 2000 (GB) 100 24 935.3
Feb. 26, 2001 (GB) 101 09 225.3

(51) Int. Cl. C08F 8/30

(52) U.S. Cl. 525/178

(57) ABSTRACT

The present invention relates to polymer blends containing

A) polyamide,

B) graft polymer, prepared by means of a mass, solution or mass-suspension polymerisation process, of

B1) from 50 to 99 wt. % of one or more vinyl monomers on

B2) from 50 to 1 wt. % of one or more graft bases having a glass transition temperature <10° C.,

or high-impact polystyrene,

C) at least one compatibility mediator containing at least one thermoplastic polymer having polar groups, and, optionally,

D) at least one vinyl (co)polymer.

The present invention relates to polymer blends containing compatibility mediators and based on polyamide and rubber-modified polymers prepared by a mass polymerisation process, which polymer blends exhibit very good mechanical properties such as tensile strength and elongation at tear.

EP-A-202 214 describes polyamide/ABS blends which additionally contain compatibility mediators having functional groups which are able to react with the amine or acid terminal groups of the polyamides.

DE-A-39 38 421 describes thermoplastic moulding compositions of polyamides with the use of graft polymers which are prepared according to a particular procedure of redox polymerisation and contain tertiary butyl acrylates in the shell.

Finally, EP-A-785 234 describes polymer compositions which contain graft polymers of aromatic vinyl monomers and monomers of alkyl (meth)acrylates or acrylonitrile on a rubber as a first component, a thermoplastic polymer having polar groups as a second component, and a compatibility mediator as a third component.

The object of the present invention is to provide polymer blends having excellent mechanical properties such as tensile strength and elongation at tear.

It has now been found that polymer blends which are based on polyamide and mass ABS or on polyamide and high-impact polystyrene and which contain compatibility mediators exhibit the desired properties.

Accordingly, the invention provides polymer blends containing

A) polyamide,

B) graft polymer, prepared by means of a mass, solution or mass-suspension polymerisation process, of

B1) from 50 to 99 wt. % of one or more vinyl monomers on

B2) from 50 to 1 wt. % of one or more graft bases having a glass transition temperature <10° C.,

or high-impact polystyrene,

C) at least one compatibility mediator containing at least one thermoplastic polymer having polar groups, and, optionally,

D) at least one vinyl (co)polymer.

The invention preferably provides polymer blends containing

from 10 to 98 parts by weight, preferably from 15 to 70 parts by weight, particularly preferably from 20 to 60 parts by weight, of component A,

from 0.5 to 80 parts by weight, preferably from 10 to 70 parts by weight, particularly preferably from 20 to 65 parts by weight, of a mixture consisting of components B and, optionally, D, and

from 0.5 to 50 parts by weight, preferably from 1 to 30 parts by weight, particularly preferably from 2 to 10 parts by weight, of component C.

### Component A

Suitable polyamides are known homopolyamides, copolyamides and mixtures of those polyamides. They may be semi-crystalline and/or amorphous polyamides. Suitable semi-crystalline polyamides are polyamide-6, polyamide-6,6, mixtures and corresponding copolymers of those components. There come into consideration also semi-crystalline polyamides, the acid component of which consists wholly or partially of terephthalic acid and/or isophthalic acid and/or suberic acid and/or sebacic acid and/or azelaic acid and/or adipic acid and/or cyclohexanedicarboxylic acid, the diamine component of which consists wholly or partially of m- and/or p-xylylene-diamine and/or hexamethylenediamine and/or 2,2,4-trimethylhexamethylenediamine and/or 2,4,4-trimethylhexamethylenediamine and/or isophoronediamine, and the composition of which is known in principle.

Mention may additionally be made of polyamides which are prepared wholly or partially from lactams having from 7 to 12 carbon atoms in the ring, optionally with the concomitant use of one or more of the above-mentioned starting components.

Particularly preferred semi-crystalline polyamides are polyamide-6 and polyamide-6,6 and mixtures thereof. Known products may be used as amorphous polyamides. They are obtained by the polycondensation of diamines, such as ethylenediamine, hexamethylenediamine, decamethylenediamine, 2,2,4- and/or 2,4,4-trimethylhexamethylenediamine, m- and/or p-xylylene-diamine, bis-(4-aminocyclohexyl)-methane, bis-(4-aminocyclohexyl)-propane, 3,3′-dimethyl-4,4′-diamino-dicyclohexyl-methane, 3-aminomethyl-3,5,5-trimethylcyclohexylamine, 2,5- and/or 2,6-bis-(aminomethyl)-norbornane and/or 1,4-diaminomethylcyclohexane, with dicarboxylic acids, such as oxalic acid, adipic acid, azelaic acid, decanedicarboxylic acid, heptadecanedicarboxylic acid, 2,2,4- and/or 2,4,4-trimethyladipic acid, isophthalic acid and terephthalic acid.

Also suitable are copolymers obtained by the polycondensation of several monomers, as well as copolymers prepared with the addition of aminocarboxylic acids such as ε-aminocaproic acid, ω-aminoundecanoic acid or (ω-aminolauric acid or their lactams.

Particularly suitable amorphous polyamides are polyamides prepared from isophthalic acid, hexamethylenediamine and other diamines such as 4,4-diamino-dicyclohexylmethane, isophoronediamine, 2,2,4- and/or 2,4,4-trimethylhexamethylenediamine, 2,5- and/or 2,6-bis-(aminomethyl)-norbomene; or from isophthalic acid, 4,4′-diamino-dicyclohexylmethane and caprolactam; or from isophthalic acid, 3,3′-dimethyl-4,4′-diamino-dicyclohexyhnethane and lauryl lactam; or from terephthalic acid and the isomeric mixture of 2,2,4- and/or 2,4,4-trimethylhexamethylenediamine.

Instead of the pure 4,4′-diaminodicyclohexylmethane it is also possible to use mixtures of the position isomers diaminedicyclohexalmethanes, which are composed of

| | |
|---|---|
| from 70 to 99 mol % | of the 4,4′-diamino isomer |
| from 1 to 30 mol % | of the 2,4′-diamino isomer |
| from 0 to 2 mol % | of the 2,2′-diamino isomer |

optionally according to more highly condensed diamines, which are obtained by hydrogenation of commercial grade diaminodiphenylmethane. Up to 30% of the isophthalic acid may be replaced by terephthalic acid.

The polyamides preferably have a relative viscosity (measured on a 1 wt. % solution in m-cresol at 25° C.) of from 2.0 to 5.0, particularly preferably from 2.5 to 4.0.

### Component B

Component B consists of one or more rubber-modified graft polymers. The rubber-modified graft polymer B contains a random (co)polymer of monomers according to B.1.1 and B.1.2, as well as a rubber B.2 grafted with the random (co)polymer of B.1.1 and B.1.2, the preparation of B being carried out in a known manner according to a mass or solution or mass-suspension polymerisation process, as described, for example, in U.S. Pat. Nos. 3,243,481, 3,509,237, 3,660,535, 4,221,833 and 4,239,863.

Examples of monomers B.1.1 are styrene, α-methylstyrene, styrenes substituted at the nucleus by halogen or by alkyl, such as p-methylstyrene, p-chlorostyrene, (meth)acrylic acid C₁-C₈-alkyl esters, such as methyl methacrylate, n-butyl acrylate and tert-butyl acrylate. Examples of monomers B.1.2 are unsaturated nitrites, such as acrylonitrile, methacrylonitrile, (meth)acrylic acid C₁-C₈-alkyl esters, such as methyl methacrylate, n-butyl acrylate, tert-butyl acrylate, derivatives (such as anhydrides and imides) of unsaturated carboxylic acids, such as maleic anhydride and N-phenyl-maleimide, or mixtures thereof.

Preferred monomers B.1.1 are styrene, α-methylstyrene and/or methyl methacrylate, and preferred monomers B.1.2 are acrylonitrile, maleic anhydride and/or methyl methacrylate.

Particularly preferred monomers are B.1.1 styrene and B.1.2 acrylonitrile.

Rubbers B.2 suitable for the rubber-modified graft polymers B are, for example, diene rubbers, EP(D)M rubbers, that is to say rubbers based on ethylene/propylene and, optionally, diene, acrylate, polyurethane, silicone, chloroprene and ethylene/vinyl acetate rubbers.

Preferred rubbers B.2 are diene rubbers (e.g. based on butadiene, isoprene, etc.) or mixtures of diene rubbers or copolymers of diene rubbers or mixtures thereof with further copolymerisable monomers (e.g. according to B.1.1 and B.1.2), with the proviso that the glass transition temperature of component B.2 is below 10° C., preferably below −10° C. Particular preference is given to pure polybutadiene rubber.

If necessary, and if the rubber properties of component B.2 are not impaired thereby, component B may additionally contain small amounts, customarily less than 5 wt. %, preferably less than 2 wt. %, based on B.2, of ethylenically unsaturated monomers having crosslinking action. Examples of such monomers having crosslinking action are alkylenediol di(meth)acrylates, polyester di(meth)acrylates, divinylbenzene, trivinylbenzene, triallyl cyanurate, allyl (meth)acrylate, diallyl maleate and diallyl fumarate.

The rubber-modified graft polymer B is obtained by the graft polymerisation of from 50 to 99 parts by weight, preferably from 65 to 98 parts by weight, particularly preferably from 75 to 97 parts by weight, of a mixture of from 50 to 99 parts by weight, preferably from 60 to 95 parts by weight, of monomers according to B.1.1 and from 1 to 50 parts by weight, preferably from 5 to 40 parts by weight, of monomers according to B.1.2 in the presence of from 1 to 50 parts by weight, preferably from 2 to 35 parts by weight, particularly preferably from 2 to 15 parts by weight, in particular from 2 to 13 parts by weight, of the rubber component B.2, the graft polymerisation being carried out according to a mass or solution or mass-suspension polymerisation process.

In the preparation of the rubber-modified graft polymer B, it is important that the rubber component B.2 be present in the mixture of the monomers B.1.1 and B.1.2 in dissolved form prior to the graft polymerisation. Accordingly, the rubber component B.2 must not be crosslinked to such an extent that a solution in B.1.1 and B.1.2 becomes impossible, nor must B.2 already be present in the form of discrete particles at the beginning of the graft polymerisation. The particle morphology and increasing crosslinking, which are important for the product properties of B, develop only in the course of the graft polymerisation (see in this connection, for example, Ullmann, Encyclopädie der technischen Chemie, Vol. 19, p. 284 ff, 4th edition 1980).

The random copolymer of B.1.1 and B.1.2 is usually present in the polymer B partially grafted in or onto the rubber B.2, the graft mixed polymer forming discrete particles in the polymer B. The proportion of the copolymer of B.1.1 and B.1.2 grafted on or in in the total copolymer of B.1.1 and B.1.2—that is to say, the graft yield (=ratio by weight of the graft monomers actually grafted to the graft monomers used in total×100, given in %)—is to be from 2 to 40%, preferably from 3 to 30%, particularly preferably from 4 to 20%.

Within the scope of the present invention, graft polymer B) is to be understood as meaning the product, formed in the graft polymerisation, of grafted rubber and the (co)polymer formed in the graft polymerisation. The amounts of (co)polymer necessarily formed in the graft polymerisation depend inter alia on the monomer composition and the polymnerisation method. Since, according to the nature and amount of the (co)polymer D) added separately, the latter cannot be distinguished from the (co)polymer formed in the polymerisation of the graft polymer, the sum of the amounts of components B) and D) corresponds to the sum of graft and (co)-polymers.

The mean particle diameter of the resulting grafted rubber particles (determined by counting on electron microscope pictures) is in the range of from 0.5 to 5 μm, preferably from 0.8 to 2.5 μm.

High-impact polystyrene within the scope of the present invention is rubber-modified polystyrene or rubber-containing polystyrene, as is described in EP-A 878 506 (incorporated by reference).

Preferred high-impact polystyrene is a graft polymer which is generally obtainable by polymerisation of at least one aromatic vinyl monomer (styrene, α-alkylstyrenes, e.g. α-methylstyrene), alkylstyrenes (e.g. o-, m- or p-methylstyrene), preferably styrene, in the presence of a graft base in a known manner (mass, mass-suspension, solution or emulsion polymerisation).

There may be used as the graft base diene rubbers (preferably polybutadiene, polyisoprene, styrene/butadiene copolymers, particularly preferably polybutadiene), ethylene/vinyl acetate copolymers, acrylate rubbers, ethylene/propylene rubbers (EPDM's), alone or in admixture. Particularly preferred graft bases are polybutadiene and styrene/butadiene copolymers. The rubber content in the high-impact polystyrene is generally from 2 to 30 wt. %, preferably from 5 to 25 wt. %, particularly from 5 to 20 wt. %. In the graft polymerisation, copolymers are necessarily formed. The definition of high-impact polystyrene therefore also includes the graft polymer and the copolymer formed in the graft polymerisation.

Details are to be found in EP-A 878 506.

### Component C

According to the invention there are used as compatibility mediators preferably thermoplastic polymers having polar groups.

Accordingly, there are used according to the invention polymers which contain

C.1 a vinyl aromatic monomer,

C.2 at least one monomer selected from the group C₂- to C₁₂-allyl methacrylates, C₂- to C₁₂-alkyl acrylates, methacrylonitriles and acrylonitriles, and

C.3 α,β-unsaturated components containing dicarboxylic acid anhydrides.

Particular preference is given to styrene as the vinyl aromatic monomer C.1.

Acrylonitrile is particularly preferred as component C.2.

Particular preference is given to maleic anhydride as the α,β-unsaturated component containing dicarboxylic acid anhydrides C.3.

There are used as components C.1, C.2 and C.3 preferably terpolymers of the mentioned monomers. Accordingly, terpolymers of styrene, acrylonitrile and maleic anhydride are preferably used. Those terpolymers contribute particularly towards improving the mechanical properties, such as tensile strength and elongation at tear. The amount of maleic anhydride in the terpolymer may vary within wide limits. The amount is preferably from 0.2 to 5 mol %. Amounts of from 0.5 to 1.5 mol % are particularly preferred. Within that range, particularly good mechanical properties in respect of tensile strength and elongation at tear are achieved.

The terpolymer may be prepared in a manner known per se. A suitable method is to dissolve monomer components of the terpolymer, for example the styrene, maleic anhydride or acrylonitrile, in a suitable solvent, for example methyl ethyl ketone (MEK). One or, optionally, more than one chemical initiator is added to that solution. Suitable initiators are, for example, peroxides. The mixture is subsequently polymerised for several hours at elevated temperatures. The solvent and the unreacted monomers are then removed in a manner known per se.

The ratio of component C.1 (vinyl aromatic monomer) to component C.2, for example the acrylonitrile monomer, in the terpolymer is preferably from 80:20 to 50:50. In order to improve the miscibility of the terpolymer with the graft copolymer B, the amount of vinyl aromatic monomer C.1 chosen preferably corresponds to the amount of vinyl monomer B.1 in the graft copolymer B.

The amount of component C in the polymer blends according to the invention is from 0.5 to 50 wt. %, preferably from 1 to 30 wt. %, particularly preferably from 2 to 10 wt. %. Very particular preference is given to amounts of from 5 to 7 wt. %.

Such polymers are described, for example, in EP-A-785 234 and EP-A-202 214. Particular preference is given according to the invention to the polymers mentioned in EP-A-202 214.

### Component D

Component D consists of one or more thermoplastic vinyl (co)polymers D.

Suitable vinyl (co)polymers D are polymers of at least one monomer from the group of the vinyl aromatic compounds, vinyl cyanides (unsaturated nitrites), (meth)acrylic acid (C₁-C₈)-alkyl esters, unsaturated carboxylic acids and derivatives (such as anhydrides and imides) of unsaturated carboxylic acids. (Co)polymers of

D.1 from 50 to 99 parts by weight, preferably from 60 to 80 parts by weight, of vinyl aromatic compounds and/or vinyl aromatic compounds substituted at the nucleus, such as, for example, styrene, α-methylstyrene, p-methylstyrene, p-chlorostyrene, and/or methacrylic acid (C₁-C₈)-alkyl esters, such as, for example, methyl methacrylate, ethyl methacrylate, and

D.2 from 1 to 50 parts by weight, preferably from 20 to 40 parts by weight, of vinyl cyanides (unsaturated nitrites), such as acrylonitrile and methacrylonitrile, and/or (meth)acrylic acid (C₁-C₈)-alkyl esters (such as, for example, methyl methacrylate, n-butyl acrylate, tert-butyl acrylate) and/or unsaturated carboxylic acids (such as maleic acid) and/or derivatives (such as anhydrides and imides) of unsaturated carboxylic acids (for example, maleic anhydride and N-phenyl-maleimide) are particularly suitable.

The (co)polymers D are resin-like, thermoplastic and rubber-free.

The copolymer of D.1 styrene and D.2 acrylonitrile is particularly preferred.

The (co)polymers according to D are known and can be prepared by radical polymerisation, in particular by emulsion, suspension, solution or mass polymerisation. The (co)polymers preferably have molecular weights \overline{M}_{w} (weight average, determined by light scattering or sedimentation) of from 15,000 to 200,000.

### Component E

The polymer blends according to the invention may contain conventional additives, such as flameproofing agents, anti-dripping agents, very finely divided inorganic compounds, lubricants and mould-release agents, nucleating agents, antistatics, stabilisers, fillers and reinforcing agents, as well as colourings and pigments.

The polymer blends according to the invention may generally contain from 0.01 to 20 wt. %, based on the total moulding composition, of flameproofing agents. There may be mentioned as examples of flameproofing agents organic halogen compounds, such as decabromobisphenyl ether, tetrabromobisphenol, inorganic halogen compounds, such as ammonium bromide, nitrogen compounds, such as melamine, melamine/formaldehyde resins, inorganic hydroxide compounds, such as Mg-Al hydroxide, inorganic compounds such as aluminium oxides, titanium dioxides, antimony oxides, barium metaborate, hydroxo antimonate, zirconium oxide, zirconium hydroxide, molybdenum oxide, ammonium molybdate, tin borate, ammonium borate and tin oxide, as well as siloxane compounds.

Phosphorus compounds, as are described in EP-A-363 608, EP-A-345 522 or EP-A-640 655, may also be used as flameproofing agents.

The inorganic compounds which may be used include compounds of one or more metals of main groups 1 to 5 and of sub-groups 1 to 8 of the periodic system, preferably of main groups 2 to 5 and of sub-groups 4 to 8, particularly preferably of main groups 3 to 5 and of sub-groups 4 to 8, with the elements oxygen, sulfur, boron, phosphorus, carbon, nitrogen, hydrogen and/or silicon.

Examples of such compounds are oxides, hydroxides, hydrous oxides, sulfates, sulfites, sulfides, carbonates, carbides, nitrates, nitrites, nitrides, borates, silicates, phosphates, hydrides, phospbites or phosphonates. Those compounds include, for example, TiN, TiO₂, SnO₂, WC, ZnO, Al₂O₃, AlO(OH), ZrO₂, Sb₂O₃, SiO₂, iron oxides, NaSO₄, BaSO₄, vanadium oxides, zinc borate, silicates such as Al silicates, Mg silicates, one-, two- and three-dimensional silicates, mixtures and doped compounds may also be used. Furthermore, those nano-scale particles may be surface-modified with organic molecules in order to achieve better compatibility with the polymers. In that manner, hydrophobic or hydrophilic surfaces may be produced.

The average particle diameters are less than or equal to 200 nm, preferably less than or equal to 150 mn, in particular from 1 to 100 nm.

Particle size and particle diameter always mean the mean particle diameter d₅₀, determined by ultracentrifuge measurements according to W. Scholtan et al. Kolloid-Z. und Z. Polymere 250 (1972), p.782 to 796.

The inorganic compounds may be present in the form of powders, pastes, sols, dispersions or suspensions. Powders can be obtained from dispersions, sols or suspensions by precipitation.

The powders may be incorporated into the thermoplastic plastics by conventional processes, for example by direct kneading or extrusion of the constituents of the moulding composition and the very finely divided inorganic powders. Preferred processes are the preparation of a masterbatch, for example in flameproofing additives, other additives, monomers, solvents, in component A or the co-precipitation of dispersions of component B or C with dispersions, suspensions, pastes or sols of the very finely divided inorganic materials.

There come into consideration as fillers and reinforcing materials, for example, glass fibres, which may optionally be cut or ground, glass beads, glass spheres, plate-like reinforcing material, such as kaolin, talc, mica, silicates, quartz, talcum, titanium dioxide, wollastonite, carbon fibres, or mixtures thereof. Cut or ground glass fibres are preferably used as the reinforcing material. Preferred fillers, which may also have a reinforcing effect, are glass spheres, mica, silicates, quartz, talcum, titanium dioxide, wollastonite.

The polymer blends of the present invention may be used in the production of moulded bodies of any kind. In particular, moulded bodies may be produced by injection moulding. Examples of moulded bodies which may be produced are: housing parts of any kind, for example for domestic appliances, such as juice extractors, coffee machines, mixers, for office machines, such as computers, printers, monitors, or cover plates for the construction sector and parts for the automotive sector.

The present invention relates also to the use of the polymer blends according to the invention in the production of mouldings, and to the mouldings themselves.

The polymer blends are particularly suitable for the production of mouldings of which particularly high requirements are made in respect of elongation at tear and tensile strength.

The invention is illustrated in greater detail below with reference to some examples:

### EXAMPLES

### 1. Components Used

| | |
|---|---|
| A | Polyamide (DURETHAN B30 from Bayer AG, Leverkusen, |
| | Germany) |
| B1 | Graft polymer of 40 parts by weight of a copolymer of styrene and |
| | acrylonitrile in a ratio of 73:27 on 60 parts by weight of particulate |
| | crosslinked polybutadiene rubber (mean particle diameter d₅₀ = |
| | 0.28 μm), prepared by emulsion polymerisation |
| B2 | Mass ABS |
| | (1) Magnum 3504 = mass ABS polymer from DOW Chemical |
| | Company Midland, Michigan USA |
| | (2) Lustran LTD from Bayer AG |
| B3 | High-impact polystyrene (polystyrene 495F, BASF AG, |
| | Ludwigshafen, Germany) |
| C1 | Compatibility mediator: terpolymer of styrene and acrylonitrile (ratio |
| | by weight of 2.1:1, containing 1 mol % maleic anhydride) |
| C2 | Styrene/isopropylene/2-oxazoline copolymer having a weight-average |
| | M_{w} of approximately 15.2 × 10⁴ kg/mol measured by means of GPC |
| | with polystyrene-standard calibration (Epocros ® RPS-1005 from |
| | Nippon Shokubai Co. Ltd., Japan) |
| D | Styrene/acrylonitrile copolymer having a styrene/acrylonitrile ratio of |
| | 72:28 and an intrinsic viscosity of 0.75 dl/g (measured in |
| | dimethylformamide at 20° C.) |
| F | Additives |

### 2. Preparation of the Polymer Blends

The polymer blends according to the invention are prepared by mixing the respective constituents in a known manner and melt-compounding or melt-extruding at temperatures of from 200 to 300° C. in conventional apparatuses, such as internal kneaders, extruders and double-shaft screws, the fluorinated polyolefins preferably being used in the form of the already mentioned coagulated mixture.

The individual constituents may in a known manner be mixed either in succession or simultaneously, either at approximately 20° C. (room temperature) or at elevated temperature.

### 3. Mass ABS or Mixture of Mass ABS and Emulsion ABS and HIPS

TABLE 1

| | | Comparison | | |
|---|---|---|---|---|
| | | example | | |
| | | according to | | |
| | | EP-A 202 214 | Example 1 | Example 2 |
| A | parts by wt. | 34 | 34 | 34 |
| B1 | parts by wt. | 39.6 | — | — |
| B2 | parts by wt. | — | 60(1) | 60(2) |
| C1 | parts by wt. | 6 | 6 | 6 |
| D | parts by wt. | 20.4 | — | — |
| F | parts by wt. | 1.5 | 1.5 | 1.5 |
| Vicat B | ° C. | 100 | 111 | 111 |
| HDT A | ° C. | 74 | 86 | 86 |
| Modulus of | MPa | 1630 | 2320 | 2230 |
| elasticity | | | | |
| Elongation at | % | 37 | 53 | 50 |
| tear | | | | |

### 4. With HIPS

| | | Example 1 | Example 2 | Example 3 |
|---|---|---|---|---|
| A | parts by wt. | 44 | 44 | 44 |
| B | parts by wt. | — | — | — |
| B3 | parts by wt. | 44 | 48 | 52 |
| C2 | parts by wt. | 12 | 8 | 4 |
| D | parts by wt. | — | — | — |
| F | parts by wt. | 1.5 | 1.5 | 1.5 |
| Modulus of | MPa | 2400 | 2300 | 2237 |
| elasticity | | | | |

Determination of heat distortion according to Vicat B is carried out in accordance with DIN 53 460 (ISO 306) on rods measuring 80×10×4 mm.

HDT A was determined at 1.8 MPa in accordance with ISO 75

The melt volume rate was determined in accordance with ISO 527

Weathering was determinied in accordance with SAE J 1885

Uerit device: Xe WO 11

Spray cycle: 102=18

Lighting time: 1000 h

Irradiation energy: 1260 KJ/m²

Irradiation: 144.9 MJ/m²

The modulus of elasticity was determined in accordance with DIN 53 457/ISO 527

The elongation at tear was determined in accordance with ISO 527

1. Polymer blends containing
A) polyamide,
B) graft polymer, prepared by means of a mass, solution or mass-suspension polymerisation process, of
B.1 from 50 to 99 wt. % of one or more vinyl monomers on
B.2 from 50 to 1 wt. % of one or more graft bases having a glass transition temperature <10° C.,
or high-impact polystyrene,
C) at least one compatibility mediator containing at least one thermoplastic polymer having polar groups, and, optionally,
D) at least one vinyl (co)polymer.

2. Polymer blends according to claim 1, characterised in that they contain from 10 to 98 parts by weight of polyamide,
from 0.5 to 80 parts by weight of a mixture of components B and, optionally, D, and
from 0.5 to 50 parts by weight of component C.

3. Polymer blends according to claim 1, characterised in that they contain from 15 to 70 parts by weight of polyamide,
from 10 to 70 parts by weight of a mixture of components B and, optionally, D, and from 1 to 30 parts by weight of component C.

4. Polymer blends according to claim 1, characterised in that they contain from 20 to 60 parts by weight of polyamide,
from 20 to 65 parts by weight of a mixture of components B and, optionally, D, and
from 2 to 10 parts by weight of component C.

5. Polymer blends according to any one of the preceding claims, wherein vinyl monomers B.1 are mixtures of
B.1.1 styrene, α-methylstyrene, styrenes substituted at the nucleus by halogen or by alkyl, and/or (meth)acrylic acid C₁-C₈-alkyl esters, and
B.1.2 unsaturated nitrites, (meth)acrylic acid C₁-C₈-alkyl esters and/or derivatives of unsaturated carboxylic acids.

6. Polymer blends according to any one of the preceding claims, characterised in that component C contains at least one vinyl aromatic monomer (C.1) selected from the group C₂-C₁₂-alkyl (meth)acrylates, methacrylonitriles and acrylonitriles, as well as α,β-unsaturated components containing dicarboxylic acid anhydrides (C.2).

7. Polymer blends according to any one of the preceding claims, wherein component D is vinyl (co)polymers of at least one monomer from the group of the vinyl aromatic compounds, vinyl cyanides, (meth)acrylic acid (C₁-C₈)-alkyl esters, unsaturated carboxylic acids, and derivatives of unsaturated carboxylic acids.

8. Polymer blends according to any one of the preceding claims containing at least one additive selected from the group of the lubricants and mould-release agents, nucleating agents, antistatics, stabilisers, colourings and pigments.

9. Polymer blends according to any one of the preceding claims containing a flameproofing agent.

10. Use of the polymer blends according to any one of the preceding claims in the production of moulded bodies.

11. Moulded bodies obtainable from polymer blends according to any one of claims 1 to 9.

12. Housing parts, cover plates and parts for the automotive sector, obtainable from polymer blends according to any one of claims 1 to 9.
